(19) United States
(12) Patent Application Publication
(10) Pub. No.: US 2017/0241291 A1
(43) Pub. Date: Aug. 24, 2017

(54) TURBINE INTERMEDIATE CASING AND SEALING ARRANGEMENT OF CERAMIC FIBER COMPOSITE MATERIALS

(71) Applicant: MTU Aero Engines AG, Munich (DE)

(72) Inventor: Alexander BOECK, Kottgeisering (DE)

(21) Appl. No.: 15/430,606

(22) Filed: Feb. 13, 2017

(30) Foreign Application Priority Data
Feb. 22, 2016 (EP) 16156677.3

(51) Int. Cl. F01D 25/24; F01D 25/16; F01D 11/00

(52) U.S. Cl. CPC F01D 25/243; F01D 11/003; F01D 25/162; F05D 2220/32; F05D 2300/6033; F05D 2300/10; F05D 2300/20; F05D 2300/501

(57) ABSTRACT

A turbine intermediate casing for a gas turbine comprising outer and inner wall elements arranged in series in circumferential direction and delimiting a flow passage for exhaust gas; strut fairing elements arranged in radial direction between respective outer and inner wall elements; an outer casing encompassing the outer and inner wall elements; and an annular mounting structure encompassing a bearing region of a shaft of the gas turbine. The strut fairing elements comprise a space for accommodating carrier elements which extend from the annular mounting structure through the flow passage to the outer casing exhaust gas flowing through the flow passage being directed by the strut fairing elements around the carrier elements. The outer and inner wall and strut fairing elements comprise ceramic fiber composite materials, the outer and inner wall elements being connected to the outer casing and the annular mounting structure respectively.

### CROSS-REFERENCE TO RELATED APPLICATIONS

The present application claims priority under 35 U.S.C. §119 of European Patent Application No. 16156677.3, filed Feb. 22, 2016, the entire disclosure of which is expressly incorporated by reference herein.

### BACKGROUND OF THE INVENTION

1. Field of the Invention

The invention relates to a turbine intermediate casing for a gas turbine, especially to an aviation gas turbine, comprising: a plurality of outer wall elements which are arranged in sequence in the circumferential direction; a plurality of inner wall elements which are arranged in sequence in the circumferential direction, wherein the outer wall elements and the inner wall elements are delimited by the inner sides of a flow passage for exhaust gas which face each other; a plurality of strut fairing elements which are arranged in the radial direction between a relevant outer wall element and a relevant inner wall element; an outer casing which encompasses the outer wall elements and the inner wall elements; and an annular mounting structure which encompasses a bearing region of a shaft of the gas turbine, especially the shaft of the high-pressure turbine, wherein the strut fairing elements are designed in such a way that they have a locating space for accommodating carrier elements which extend from the annular mounting structure through the flow passage in basically the radial direction to the outer casing so that exhaust gas which flows through the flow passage is directed by means of the strut fairing elements around the carrier elements.

2. Discussion of Background Information

Turbine intermediate casings of gas turbines, especially of aviation gas turbines, serve especially for directing the exhaust gases, which exit the high-pressure turbine, with the lowest possible aerodynamic losses past structural components and pipelines into the low-pressure turbine. Also, the turbine intermediate casing, as a support structure, accommodates at least one bearing of the shaft of the high-pressure turbine. A turbine intermediate casing is therefore exposed to high stresses during operation of the gas turbine, especially to mechanical and thermal stresses.

In the case of the mechanical stresses, factors such as the weight of the installed components and also their structural interconnections are especially to be considered. In the case of conventional fairing elements, especially produced from metal materials, it is customary, for example, to interconnect the outer wall elements and the inner wall elements by means of the strut fairing elements so that this entire structure is fastened and supported on the outer casing, wherein the inner wall elements are fastened on the strut fairing elements which in turn are connected to the outer wall elements. This leads to the transfer of mechanical and also thermal loads from the referenced components to the outer casing.

It would be advantageous to be able to improve a turbine intermediate casing to the effect that disadvantages specified above can be avoided. Being able to reduce the weight and being able to reduce the transfer of mechanical or thermal stresses to other components is especially to be achieved.

### SUMMARY OF THE INVENTION

The present invention provides a turbine intermediate casing for a gas turbine, especially for an aviation gas turbine. The casing comprises:
a plurality of outer wall elements which are arranged in series in the circumferential direction;
a plurality of inner wall elements which are arranged in series in the circumferential direction, the outer wall elements and the inner wall elements delimiting a flow passage for exhaust gas by means of inner sides thereof which face each other;
a plurality of strut fairing elements which are arranged in the radial direction (RR) between a respective outer wall element and a respective inner wall element,
an outer casing which encompasses the outer wall element and the inner wall element,
an annular mounting structure which encompasses a bearing region of a shaft of the gas turbine, especially the shaft of the high-pressure turbine. The strut fairing elements are designed in such a way that they have an accommodation space for accommodating carrier elements which extend from the annular mounting structure through the flow passage in substantially the radial direction to the outer casing so that exhaust gas which flows through the flow passage is directed by means of the strut fairing elements around the carrier elements, the outer wall elements, the inner wall elements and the strut fairing elements are produced at least partially from ceramic fiber composite materials (CMC), the outer wall elements are designed in such a way that they are connected to the outer casing, and the inner wall elements are designed in such a way that they are connected to the annular mounting structure.

In one aspect, at least some of the plurality of outer wall elements and at least some of the plurality of inner wall elements may have fairing openings in which radial ends of the strut fairing elements are accommodated. For example the strut fairing elements may be supported in a floating manner between the outer wall elements and the inner wall elements by means of respective fairing sealing arrangements.

In another aspect, adjacent outer wall elements may butt against each other by means of an outer-wall sealing arrangement and adjacent inner wall elements may butt against each other by means of an inner-wall sealing arrangement.

In yet another aspect, the fairing sealing arrangement and/or the outer-wall sealing arrangement and/or the inner wall sealing arrangement may comprise at least one sealing cord, which sealing cord may be produced as a fabric tube made from metal materials and/or ceramic materials.

In a still further aspect, the sealing cord may comprise a fabric tube with an elastic and/or deformable filling. The filling may be formed from ceramic fibers which extend in the longitudinal direction of the sealing cord.

In another aspect, at least one recess, which is associated with the respective sealing arrangement, may be formed on the strut fairing elements and/or on the outer wall elements and/or on the inner wall elements, in which recess the sealing cord is accommodated. For example, an adjoining flange section may be formed in the region of a respective recess on at least one edge of said recess.

In another aspect, by means of an outer-wall sealing arrangement abutting outer wall elements may be supported against each other by means of flange sections and/or by means of an inner-wall sealing arrangement abutting inner wall elements may be supported against each other by means of flange sections and/or by means of a fairing sealing arrangement strut fairing elements, which are accommodated between respective outer wall elements and inner wall elements, may be supported on the respective outer wall elements and inner wall elements by means of flange sections.

In another aspect, between abutting outer wall elements and/or between abutting inner wall elements and/or between strut fairing elements and their respective outer wall elements and inner wall elements, expansion gaps may be formed in the region of the respective outer-wall sealing arrangement or inner-wall sealing arrangement or fairing sealing arrangement.

In another aspect, in the accommodation space of a strut fairing element provision may be made for at least one support element, which is oriented into the accommodation space, in such a way that the strut fairing element is supported by means of the support element on the carrier element.

The present invention also provides a gas turbine, especially an aviation gas turbine, which comprises the turbine intermediate casing set forth above.

According to the invention, it is proposed that in a turbine intermediate casing the outer wall elements, the inner wall elements and the strut fairing elements are produced at least partially from ceramic fiber composite materials, wherein the outer wall elements are designed in such a way that they are connected to the outer casing and wherein the inner wall elements are designed in such a way that they are connected to the annular mounting structure.

By using ceramic fiber composite materials, which are subsequently referred to as CMC for the sake of simplicity, weight can be saved compared with metal components. However, consideration is to be given in this case to the fact that CMC components compared with metal components, on account of their unfavorable failure characteristics, have a lower useful strength so that especially larger (flat) metal components should be split into smaller CMC units. As a result of the connection to different components (outer casing or mounting structure), selected in conjunction with the use of CMC for the outer wall elements or for the inner wall elements, the outer wall elements or the inner wall elements are supported on different structural components of the turbine intermediate casing. This reduces or avoids the transfer of loads from adjacent components of the turbine intermediate casing or of the turbine via the outer wall elements or inner wall elements which are produced from CMC.

So that the transfer of loads can be further counteracted it is preferred that at least some of the plurality of outer wall elements and at least some of the plurality of inner wall elements have openings in which are accommodated radial ends of the strut fairing elements. To this end, it is furthermore proposed that by means of respective fairing sealing arrangements the strut fairing elements are mounted in a floating manner between the outer wall elements and the inner wall elements.

Since the outer wall elements are connected to or supported on the outer casing and the inner wall elements are connected to or supported on the annular mounting structure, the strut fairing elements can be accommodated in the fairing openings with a clearance. This reduces or prevents the transfer of loads between the outer wall elements and the inner wall elements via the strut fairing elements. The fairing sealing arrangement serves in this case for the sealing of the flow passage in the transition regions between the strut fairing elements and the respective outer wall elements and inner wall elements.

It is furthermore proposed that adjacent outer wall elements butt against each other by means of an outer-wall sealing arrangement and that adjacent inner wall elements butt against each other by means of an inner-wall sealing arrangement. The adjacent wall elements (outer and inner) form in each case a basically closed outer or inner ring in the circumferential direction, wherein each wall element corresponds to an annular arc section and wherein between two annular arc sections provision is made for a respective sealing arrangement so that the ring consisting of outer wall elements and the ring consisting of inner wall elements delimit a sealed flow passage.

It is preferred that the fairing sealing arrangement or/and the outer-wall sealing arrangement or/and the inner-wall sealing arrangement comprise at least one sealing cord, wherein the sealing cord is preferably produced as fabric tube consisting of metal and/or ceramic materials. To this end, it is furthermore proposed that the sealing cord comprises a fabric tube with an elastic or/and deformable filling, wherein the filling is preferably formed from ceramic fibers which extend in the longitudinal direction of the sealing cord. Alternatively, the filling can also be formed from non-directional ceramic fibers or grains. The sealing cord is preferably closed at its ends, especially being welded or stitched. Such sealing cords with a deformable or elastic filling enable the bridging of larger gaps at the sealing points. This especially also enables the bridging of manufacturing-induced tolerances and thermomechanical displacements during operation.

It is furthermore proposed that at least one recess, which is associated with the respective sealing arrangement, is formed on the strut fairing elements or/and on the outer wall elements or/and on the inner wall elements, in which recess the sealing cord is accommodated. In this case, such a recess, which can also be referred to as a groove or seal shell, can preferably be designed in a U-shaped manner. In this case, the seal shell is preferably formed integrally with the outer wall element or with the inner wall element or with the strut fairing element. In addition, the seal shell or recess can be dimensioned in such a way that it can be formed from curved continuous ceramic fibers so the rigidity of the seal shell or recess can be improved.

The sealing cord can have a diameter or radius which is selected in dependence upon the bend radius of ceramic fibers of the seal shell. By correspondingly selected bend radii in the case of the ceramic fibers of the seal shell, a contribution can be made to the mentioned improved rigidity (continuous, curved, complete fibers, no cut fibers), wherein as a result of this larger gaps which possibly develop between the components can be reliably sealed by means of the correspondingly dimensioned sealing cord with deformable or elastic filling.

It is preferred that in the region of a respective recess an adjoining flange section is formed on at least one edge of the recess. If such a recess is viewed in a position in which the recess is oriented basically horizontally so that the sealing cord would remain in the recess on account of gravity force, a respective flange section can additionally extend along the edge in the vertical direction or in the horizontal direction. In other words, the flange section, with regard to a cross section through the recess, can be formed as an especially parallel extension of the edge or can be formed as an especially orthogonal extension of the edge.

It is furthermore proposed that by means of an outer-wall sealing arrangement abutting outer wall elements are supported against each other by means of flange sections or/and by means of an inner-wall sealing arrangement abutting inner wall elements are supported against each other by means of flange sections or/and by means of a fairing sealing arrangement strut fairing elements, which are accommodated between relevant outer wall elements and inner wall elements, are supported on the respective outer wall elements and inner wall elements by means of flange sections. It is furthermore preferred that between abutting outer wall elements or/and between abutting inner wall elements or/and between strut fairing elements and their relevant outer wall elements and inner wall elements expansion gaps are formed in the region of the respective outer-wall sealing arrangement or inner-wall sealing arrangement or fairing sealing arrangement. The flange sections on the different components enable a mutual supporting of the components against each other, especially in the event of thermal expansion or mechanical displacement of the components which is associated therewith during operation. In this case, the expansion gaps can be greatly narrowed during operation as a result of the thermo-mechanical displacements so that adjacent components, especially with corresponding flange sections, can come directly into contact with each other.

In order to secure the strut fairing element in its position in the flow passage especially against pressure forces which act in the flow direction, it is proposed that at least one support element is provided in the locating space of a strut fairing element, and directed into said locating space, in such a way that the strut fairing element is supported on the carrier element by means of the support element. If, for simplification, it is assumed that the flow direction extends basically axially along the gas turbine, the support element extends in the axial direction into the locating space of the strut fairing element so that it is supported on the carrier element in the axial direction.

The invention also relates to a gas turbine, especially to an aviation gas turbine, having a turbine intermediate casing which has at least one of the features which is described above.

### BRIEF DESCRIPTION OF THE DRAWINGS

The invention is described below with reference to the attached drawings by way of example and based on one embodiment without limitation. In particular,

FIG. 1 shows a simplified schematic sectional view of a turbine intermediate casing;

FIG. 2 shows in a schematic perspective partial view an outer wall element and a strut fairing element which is inserted into an opening of the outer wall element;

FIG. 3 shows a partially sectioned schematic perspective view of the outer wall element and the strut fairing element which is accommodated therein approximately along a line of intersection III-III of FIG. 2;

FIG. 4 shows the radially upper region of the strut fairing element in a simplified schematic representation;

FIG. 5 shows a simplified and schematic sectional view, approximately corresponding to the line of intersection V-V in FIG. 2;

FIG. 6 is a generalized form of the view of a recess with a sealing cord accommodated therein; and

FIG. 7 shows a sealing cord for use in the recess shown in FIG. 6.

### DETAILED DESCRIPTION OF EMBODIMENT OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

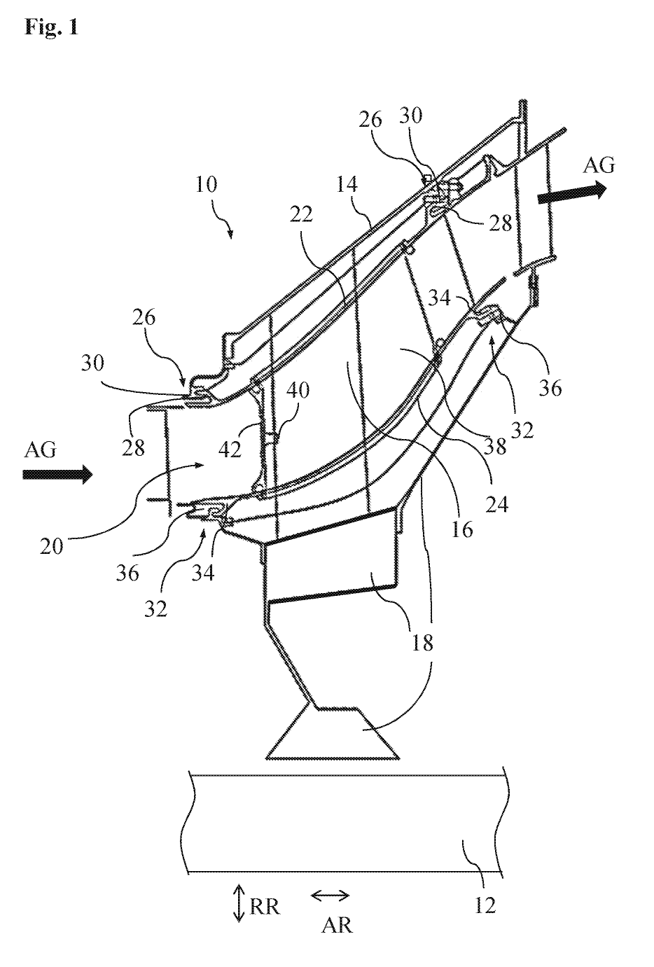

FIG. 1 shows a simplified schematic sectional view of a turbine intermediate casing 10, subsequently also referred to as a TCF (turbine center frame). The TCF 10 is arranged around a shaft 12, indicated only schematically in FIG. 1, of a gas turbine, especially of an aviation gas turbine or of a bypass engine. The longitudinal extent of the shaft arrangement 12 is subsequently referred to as the axial direction AR. The direction which is orthogonal to this is subsequently referred to as the radial direction RR.

The turbine intermediate casing 10 comprises an outer casing 14 which is disposed radially on the outside. This outer casing 14, made from metal, is connected by carrier elements 16 to an annular radially inner mounting structure 18. Between the outer casing 14 and the mounting structure 18 provision is made for a flow passage 20 through which hot exhaust gases can flow especially from the high-pressure turbine to the low-pressure turbine, which flow is indicated by the two arrows AG. The flow passage 20 is delimited by a plurality of outer wall elements 22 which are adjacent in the circumferential direction and are disposed on the outside in the radial direction and by a plurality of inner wall elements 24 which are adjacent in the circumferential direction and are disposed on the inside in the radial direction.

The outer wall elements 22 are connected to the outer casing 14 by suitable connecting arrangements 26. In the present example, the outer wall elements 22, on their two axial ends, have hook-like projections 28 which engage with corresponding mating pieces 30 of the outer casing 14.

The inner wall elements 24 are connected to the annular mounting structure 18 by suitable connecting arrangements 32. The inner wall elements 24, on their axial ends, have hook-like projections 34 which are accommodated in corresponding mating pieces 36 of the mounting structure 18.

As evident from FIG. 1, the carrier elements 16, which can also be referred to a support struts, or struts, extend basically in the radial direction through the flow passage 20 and also through a respective relevant inner wall element 24 and outer wall element 22. In order to feed the exhaust gas flow AG around the carrier elements 16 in the flow passage 20 provision is made between relevant outer wall elements 22 and inner wall elements 24 for strut fairing elements 38 which encompass or line the carrier elements 16 in the region of the flow passage 20 and in this case preferably have an aerodynamically optimized flow profile. The strut fairing elements 38 are accommodated in this case in respective openings in the outer wall elements 22 or in the inner wall elements 24, wherein the strut fairing elements are mounted in a floating manner between the relevant outer wall elements 22 and the relevant inner wall elements 24. Furthermore, the strut fairing elements 38, at their axially front end with regard to the flow direction of the exhaust gas AG, have a projection 40 which especially extends in the axial direction AR into the locating space for the carrier element 16 and is supported on said carrier element 16. This axial stop 40 secures the relative position of the strut fairing element 38 in relation to the carrier element 16 during operation if pressure forces act upon an axial front side 42 of the strut fairing element 38 on account of the hot exhaust gas AG.

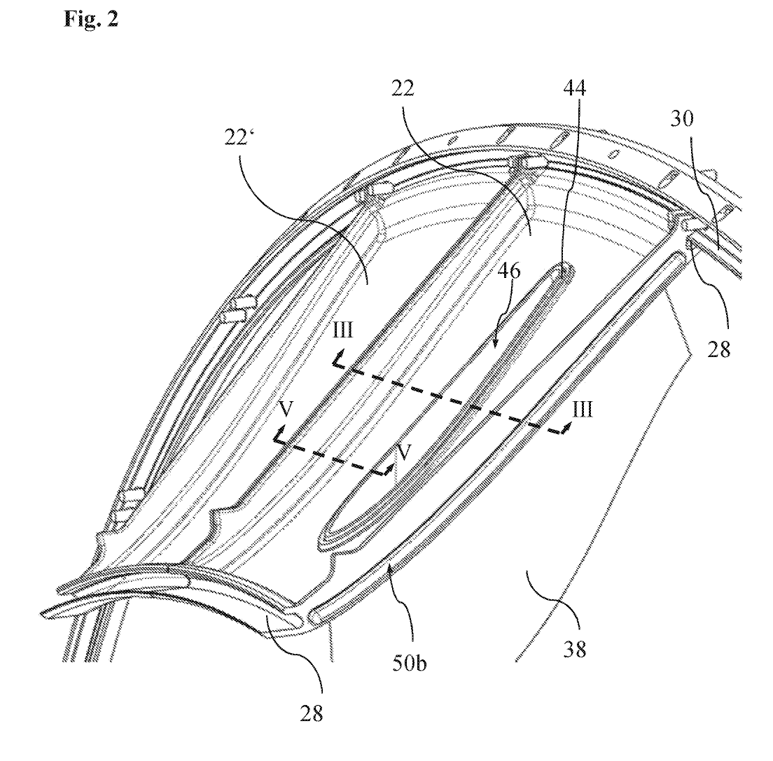

FIG. 2 shows in a schematic perspective partial view an outer wall element 22 and a strut fairing element 38 which is inserted into an opening 44 of the outer wall element 22. Also evident from this view of FIG. 2 is the locating space 46 which is formed by the strut fairing element 38 and through which the carrier element 16 can extend (FIG. 1). As already indicated with reference to FIG. 1, the outer wall element 22 in its axially front region (with regard to the flow direction of the exhaust gas) has the hook-like fastening section 28, wherein in FIG. 2 no corresponding mating piece 30 of the outer casing 14 (FIG. 1) is shown. The axially rear end of the outer wall element 22 has a further hook-like fastening element 28 which is connected to a corresponding mating piece 30 of the outer casing.

The explanation here which is by way of example for an outer wall element 22 similarly also applies to an inner wall element 24 even if such an inner wall element is not included in a corresponding view in the present application. The inner wall elements 24 also have an opening which is similar to the opening 44 and in which a radially lower end of the strut fairing element 38 can be accommodated.

With regard to FIG. 2, reference is made to the fact that of the circumferentially adjacent outer wall elements 22 not each one has, or needs to have, an opening 44 since as a rule there are fewer carrier elements 16 than outer wall elements 22 and inner wall elements 24. This is especially also indicated by the fact that there is an outer wall element 22′ in which there is no provision for an opening 44.

The outer wall elements 22, the inner wall elements 24 and the strut fairing elements 38 are partially or totally produced from ceramic fiber composite materials (CMC). As has already been mentioned in the introduction, such CMC components, on account of their unfavorable failure characteristics, have a lower usable strength compared with conventional metal components which have been used up until now for turbine intermediate casings. Therefore, more outer wall elements 22 made from CMC are required for the design of the flow passage so that each individual outer wall element and the outer wall overall can withstand the thermal-mechanical stresses. This similarly also applies to the inner wall elements 24 and to the inner wall of the flow passage 20 which is formed therefrom.

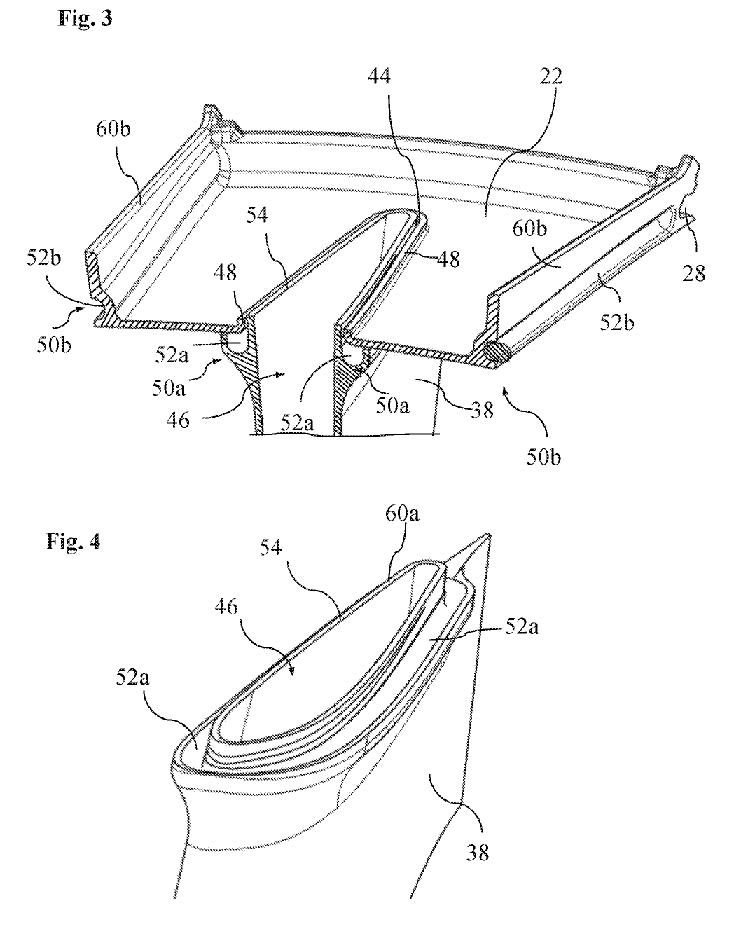

FIG. 3 shows a partially sectioned schematic perspective view of the outer wall element 22 and the strut fairing element 38 which is accommodated therein approximately along a line of intersection of FIG. 2. The strut fairing element 38 is accommodated in the opening 44 of the outer wall element 22. The opening 44 can preferably be bounded by a bead or flange-like section 48 which points in the radial direction. The strut fairing element 38 and the outer wall element 22 are supported and sealed against each other by means of a fairing sealing arrangement 50a. The fairing sealing arrangement 50a includes a recess 52a which is formed on the strut fairing element 38. The recess 52a is preferably of U-shaped or semicircle-shaped, or arc-shaped design in cross section. In the case of the strut fairing element 38, the recess 52a is arranged continuously around a wall 54 which bounds the locating space 46. For sealing the transition between strut fairing element 38 and outer wall element 22 a sealing cord 56 can be inserted into the recess 52a, which is shown schematically by way of example from FIG. 7 (sealing cord 56a). Such a sealing cord is preferably constructed as a fabric tube with a flexible or deformable filling. The filling can be formed from ceramic fibers which are oriented in the longitudinal direction of the sealing cord 56. Alternatively, the filling can also contain non-directional shorter ceramic fibers or a type of ceramic grains or ceramic granulate. The fabric tube can be produced from a ceramic fabric or a metal fabric.

The sealing arrangement 50a between the strut fairing element 38 and the outer wall element 22 which is described with reference to FIG. 3 can be constructed in a similar way between the strut fairing element 38 and the inner wall element 24. If FIG. 3 is rotated horizontally by 180° in the plane of the drawing so that FIG. 3 is upside down, it could also be considered to be a schematic representation for the arrangement of the strut fairing element 38 on an inner wall element 24.

FIG. 4 shows the radially upper region of the strut fairing element 38 in a simplified schematic representation. The recess 52a and also the wall 54 which bounds the locating space 46 are evident. Also evident from FIG. 4 is the design of the strut fairing element 38 which is as streamlined as possible so that hot exhaust gas in the flow passage can flow around it with as little resistance as possible.

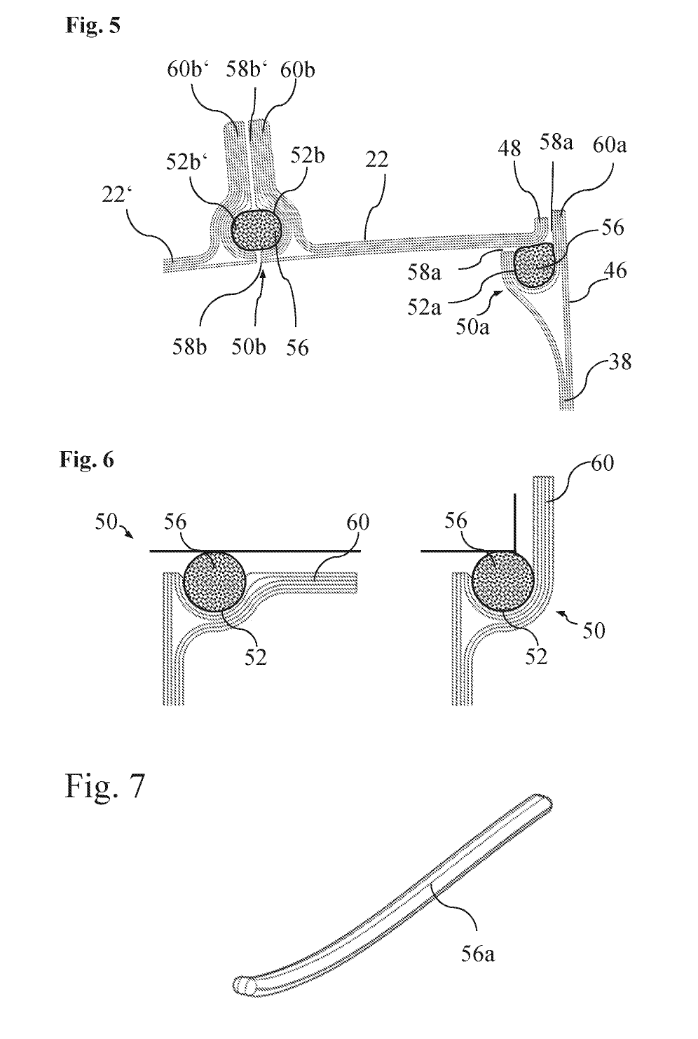

FIG. 5 shows a simplified and schematic sectional view, approximately corresponding to the line of intersection V-V in FIG. 2. Evident in FIG. 5 is an outer-wall sealing arrangement 50b which is provided between the adjacent outer wall elements 22 and 22′. Such an outer-wall sealing arrangement 50b is also partially evident in FIG. 3 and is identified by the same designations. The sealing arrangement 50b includes a recess 52b or 52b′ which is formed in the outer wall element 22 or in the outer wall element 22′, wherein this recess 52b, 52b′ is also basically of U-shaped or semicircle-shaped, or arc-shaped design in cross section. A sealing cord 56a is accommodated in the recess 52b, 52b′ (FIG. 7) so that the two outer wall elements 22, 22′ are supported and sealed against each other by means of the sealing arrangement 50b. Also evident in FIG. 5, on the right hand side, is the fairing sealing arrangement 50a with the recess 52a, which is provided on the strut fairing element 38, and the sealing cord 56 which is accommodated therein. The outer wall element 22, by the edge region 48 of the opening 44, rests upon the sealing cord 56 of the fairing sealing arrangement 50a. Also evident from FIG. 5 is that expansion gaps 58a or 58b are formed between adjoining outer wall elements, 22′ 22 or between the outer wall element 22 and the strut fairing element 38.

FIG. 6 is a generalized form of the view of a recess 52 with the sealing cord 56 accommodated therein. The recesses 52 in FIG. 6 have in each case on their right hand edge a flange section 60 which can serve for supporting forces of adjacent components which act in the region of the sealing arrangement 50. The design with an angled flange section 60 according to the left hand side of FIG. 6 is for example also realized for the flange sections 60b or 60b′ of the outer wall element 22 or 22′ of FIG. 5. A configuration corresponding to the right hand side of FIG. 6 with a flange section 60 which is parallel to the edge of the recess 52 and heightens or elongates the edge is for example realized like the flange section 60a in the case of the strut fairing element 38.

The flange section 60a of the strut fairing element 38, as is evident from FIG. 4, is arranged in an encompassing manner around the locating space 46. Therefore, the flange section 60a in basically the radial direction can be accommodated in the opening 44 of the outer wall element 22 with a clearance (expansion gap 58a). The flange section 60a, in the event of mechanical-thermal stress and expansion of the interconnected components which is associated therewith, can be supported on the bead or flange section 48 of the opening 44 so that the strut fairing element 38 and the outer wall element 22 are supported against each other in this region and overall a stabilizing effect is achieved.

The flange sections 60b or 60b′ have the expansion gaps 58b between them and in the event of mechanical-thermal stress and with expansion of the outer wall elements 22 or 22′ can butt against each other in order to support the occurring forces. The flange sections 60b or 60b′ also act as reinforcing ribs which give more stability to the outer wall element 22 or 22′.

As already mentioned above for FIG. 3. FIG. 5 can also be rotated by 180° in the plane of drawing so that it is upside down, as a result of which a schematic diagram for the situation in the case of the inner wall elements could be obtained.

As is evident from FIG. 5 and FIG. 6, the preferred positions of the fibrous tissue of the ceramic fibers of the CMC components for the outer wall elements 22, 22′ or for the strut fairing element 38 are represented by means of the thin black lines. Reference is especially made to the fact that all the recesses 52 (FIGS. 6), 52a and 52b (FIG. 5) can be formed can be formed by curved ceramic fibers. Since ceramic fibers cannot be curved with optionally small radii, all the recesses have a relatively large radius of curvature. The sealing cord 56 which is accommodated in the recesses has a radius or diameter which corresponds approximately to the radius of the recess so that the sealing cord 56 is accommodated in the recess 52 with a close fit. Since the sealing cord 56 is deformable in the transverse direction, manufacturing tolerances or necessary clearance which exist between the outer wall elements 2, or between the inner wall elements 24 or between the strut fairing elements 38 and the wall elements can therefore by adequately and reliably sealed (see for example the sealing cord 56, shown in a deformed state, of the sealing arrangement 50a in FIG. 5). The inserted sealing cords adapt in their shape to the thermal-mechanical conditions if the various components expand during operation of the gas turbine.

By using CMC for the outer wall elements 22, for the inner wall elements 24 and for the strut fairing elements 38, weight can be saved compared with a conventional metal design and also operation at higher gas temperatures is possible. Since for forming the entire outer wall or the entire inner wall more individual outer wall elements or inner wall elements have to be arranged in abutment and mutually sealed, the deformable sealing cords can be advantageously used with relatively large diameters.

As a result of the fiber orientations or fabric positions which are indicated according to FIG. 5 and FIG. 6, especially in the region of the recesses, such recesses or seal shells can be produced in one step with the entire CMC component (outer wall element 22, inner wall element 24, strut fairing element 38) without mechanical reworking. As a result of this, the problems of the non-applicability of electrical or electrochemical erosion processes which occur in the case of CMC components can be avoided.

Overall, the result is a new type of concept of the construction of fairing elements with outer wall elements, inner wall elements and strut fairing elements made from ceramic fiber composite materials in combination with a modified fastening of outer wall elements and inner wall elements on the supporting structures of the turbine intermediate casing. The chosen construction, in which the outer wall elements are fastened on the outer casing, the inner wall elements are fastened on the annular mounting structure and the strut fairing elements are accommodated in a floating manner between relevant outer wall elements and relevant inner wall elements, makes it possible to avoid the transfer of loads from adjacent components via the CMC components (outer wall elements, inner wall elements, strut fairing elements). This leads overall to a lower level of mechanical stress of these CMC components of the turbine intermediate casing.

### LIST OF REFERENCE NUMERALS

10 Turbine intermediate casing

12 Shaft arrangement

14 Outer casing

16 Carrier element

18 Mounting structure

20 Flow passage

22 Outer wall element

24 Inner wall element

26 Connecting arrangement

28 Hook-like projection

30 Mating piece

32 Connecting arrangement

34 Hook-like projection

36 Mating piece

38 Strut fairing element

40 Stop

42 Axial front side

44 Opening

46 Locating space

48 Flange-like section

50a Fairing sealing arrangement

50b Outer-wall sealing arrangement

52a/b Recess

54 Wall

56 Sealing cord

56a Sealing cord

58a/b Expansion gap

60a/b Flange section

What is claimed is:

1. A turbine intermediate casing for a gas turbine, wherein the casing comprises:
a plurality of outer wall elements which are arranged in series in circumferential direction;
a plurality of inner wall elements which are arranged in series in circumferential direction, the outer wall elements and the inner wall elements delimiting a flow passage for exhaust gas by inner sides thereof which face each other;
a plurality of strut fairing elements arranged in radial direction between a respective outer wall element and a respective inner wall element,
an outer casing encompassing the outer wall elements and the inner wall element,
an annular mounting structure which encompasses a bearing region of a shaft of the gas turbine,
the strut fairing elements being designed in such a way that they have a accommodation space for accommodating carrier elements which extend from the annular mounting structure through the flow passage in substantially the radial direction to the outer casing so that exhaust gas which flows through the flow passage is directed by the strut fairing elements around the carrier elements,
the outer wall elements, the inner wall elements and the strut fairing elements being produced at least partially from ceramic fiber composite materials (CMC),
the outer wall elements being designed in such a way that they are connected to the outer casing, and
the inner wall elements being designed in such a way that they are coupled to the annular mounting structure.

2. The turbine intermediate casing of claim 1, wherein at least some of the plurality of outer wall elements and at least some of the plurality of inner wall elements comprise fairing openings in which are accommodated radial ends of the strut fairing elements.

3. The turbine intermediate casing of claim 2, wherein the strut fairing elements are supported in a floating manner between the outer wall elements and the inner wall elements by respective fairing sealing arrangements.

4. The turbine intermediate casing of claim 1, wherein adjacent outer wall elements butt against each other by means of an outer-wall sealing arrangement and adjacent inner wall elements butt against each other by means of an inner-wall sealing arrangement.

5. The turbine intermediate casing of claim 3, wherein the fairing sealing arrangement comprises at least one sealing cord.

6. The turbine intermediate casing of claim 4, wherein the outer-wall sealing arrangement and/or the inner wall sealing arrangement comprises at least one sealing cord.

7. The turbine intermediate casing of claim 5, wherein the sealing cord is produced as a fabric tube made from metal materials and/or ceramic materials.

8. The turbine intermediate casing of claim 6, wherein the sealing cord is produced as a fabric tube made from metal materials and/or ceramic materials.

9. The turbine intermediate casing of claim 5, wherein the sealing cord comprises a fabric tube with an elastic and/or deformable filling.

10. The turbine intermediate casing of claim 6, wherein the sealing cord comprises a fabric tube with an elastic and/or deformable filling.

11. The turbine intermediate casing of claim 9, wherein the filling is formed from ceramic fibers which extend in longitudinal direction of the sealing cord.

12. The turbine intermediate casing of claim 10, wherein the filling is formed from ceramic fibers which extend in longitudinal direction of the sealing cord.

13. The turbine intermediate casing of claim 5, wherein at least one recess, which is associated with a respective sealing arrangement, is formed on the strut fairing elements, in which recess the sealing cord is accommodated.

14. The turbine intermediate casing of claim 6, wherein at least one recess, which is associated with a respective sealing arrangement, is formed on the outer wall elements and/or on the inner wall elements, in which recess the sealing cord is accommodated.

15. The turbine intermediate casing of claim 13, wherein an adjoining flange section is formed in a region of a respective recess on at least one edge of the recess.

16. The turbine intermediate casing of claim 15, wherein by an outer-wall sealing arrangement abutting outer wall elements are supported against each other by means of flange sections and/or
by an inner-wall sealing arrangement abutting inner wall elements are supported against each other by means of flange sections and/or
by a fairing sealing arrangement strut fairing elements, which are accommodated between respective outer wall elements and inner wall elements, are supported on respective outer wall elements and inner wall elements by means of flange sections.

17. The turbine intermediate casing of claim 3, wherein between strut fairing elements and their respective outer wall elements and inner wall elements, expansion gaps are formed in a region of the respective fairing sealing arrangement.

18. The turbine intermediate casing of claim 4, wherein between abutting outer wall elements and/or between abutting inner wall elements expansion gaps are formed in a region of the respective outer-wall sealing arrangement or inner-wall sealing arrangement or fairing sealing arrangement.

19. The turbine intermediate casing of claim 1, wherein in the accommodation space of a strut fairing element provision is made for at least one support element, which is oriented into the accommodation space, in such a way that the strut fairing element is supported by the at least one support element on the carrier element.

20. A gas turbine, wherein the turbine comprises the turbine intermediate casing of claim 1.
